(19) United States
(12) Patent Application Publication
(10) Pub. No.: US 2018/0334409 A1
(43) Pub. Date: Nov. 22, 2018

(54) HIGH-FLOW LIGHTWEIGHT INSULATING CONCRETE AND PREPARATION METHOD THEREOF

(71) Applicant: Shenzhen Silijia Chemical Building Materials Co., Ltd., Shenzhen (CN)

(72) Inventors: Yunguo ZHOU, Shenzhen (CN); Sijia ZHOU, Shenzhen (CN)

(73) Assignee: Shenzhen Silijia Chemical Building Materials Co., Ltd., Shenzhen (CN)

(21) Appl. No.: 15/868,971

(22) Filed: Jan. 11, 2018

(30) Foreign Application Priority Data
May 20, 2017 (CN) 201710359957.9
Dec. 25, 2017 (CN) 201711424741.2

(51) Int. Cl. C04B 28/02; C04B 24/04; C04B 18/02; C04B 40/00

(52) U.S. Cl. CPC C04B 28/02; C04B 24/04; C04B 2103/302; C04B 40/0046; C04B 40/0032; C04B 18/027

(57) ABSTRACT

The present invention discloses a high-flow lightweight insulating concrete and preparation method thereof. The high-flow lightweight insulating concrete includes cement, water, admixture and environmental friendly additives, wherein the mass ratio of the cement, admixture, environmental friendly additive and water is (15-25):(60-75):(0.5-1.5):(8-12). The present invention provides a high-flow lightweight insulating concrete and preparation method thereof, using effective gel in the construction debris as raw material. The renewable environmentally friendly active materials are prepared from the construction debris and have the characteristic of high-flow, which are suitable for the cast-in-place construction of the non-load-bearing wall. The construction process has advantages of simple, reliable, lightweight, high strength and cost-effective. And the non-load-bearing wall has the advantages of sound insulation, thermal insulation, is environmental friendly and durable.

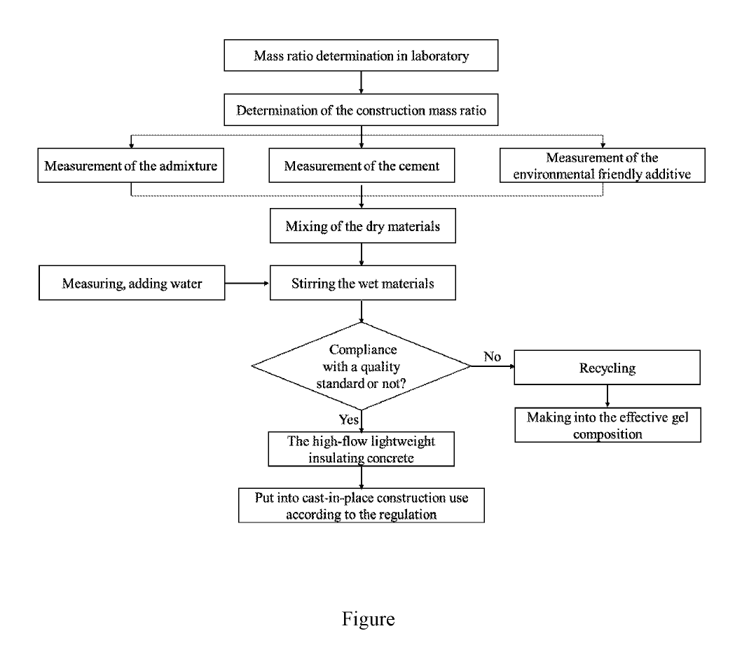

### TECHNICAL FIELD

The invention relates to the field of concrete, specifically to a high-flow lightweight insulating concrete and preparation method thereof.

### CROSS REFERENCE TO RELATED APPLICATIONS

This application is based upon and claims priority to Chinese Patent Application No. CN201710359957.9, filed on May 20, 2017, and CN201711424741.2, filed on Dec. 25, 2017 the entire contents of which are incorporated herein by reference.

### BACKGROUND

Since entering the twenty first century, economies and technology throughout the world continue to grow and march towards urbanization. As the population of cities grow, the demand for residential buildings also grows. The growth of new buildings plays a vital role in realizing the urban-rural population transfer, promoting the movement and accumulation of production factors. However, the growth of new buildings is accompanied by the following problems. Firstly, the reconstruction of old urban areas and the construction of new urban areas generate a large amount of construction debris, such as abandoned concrete blocks and discarded bricks, etc. The amount is about 3.5 billion tons each year, accounting for more than 70% of the total urban waste. The phenomenon of cities surrounded by litter is getting more and more serious, which brings severe stress to the urban construction debris collection, land occupation, urban environmental pollution and urban management. Secondly, with the rapid development of the economy and continuous improvement of people's living standards, the demand on the quality, safety, energy-efficiency and environmental protection of construction projects are increasing. Buildings are becoming more and more green, environmentally friendly, energy-efficient and comfortable. New materials and technologies are therefore needed. Thirdly, although urbanization has brought a large number of jobs, in recent years, the problem of “employment difficulties” in the construction industry has become very conspicuous. In particular, traditional hand-made walls are labor intensive, can cause occupational diseases, and skilled workers are in short supply, which hinders the progress of construction. To solve the problems mentioned above, scientific and technological innovation is an inevitable and important way.

### SUMMARY OF THE INVENTION

An objective of the present invention is to provide a high-flow lightweight insulating concrete and preparation method thereof to solve the problems mentioned above.

The technical solutions of this invention to achieve the above objective are as below:

A high-flow lightweight insulating concrete includes cement, water, an admixture and an environmental friendly additive; wherein a mass ratio of the cement, admixture, environmental friendly additive and water is (15-25):(60-75):(0.5-1.5):(8-12).

Preferably, the admixture includes a coarse aggregate and a fine aggregate.

Preferably, a mass ratio of the coarse aggregate and the fine aggregate is (36-45): (24-30).

Preferably, a size of the coarse aggregate is 8-10 mm, a size of the fine aggregate is less than 5 mm.

A preparation method of a high-flow lightweight insulating concrete, comprising the steps of:

S1: Calculating a total amount of the concrete according to a casting area of a non-load-bearing wall.

S2: Determining a mass ratio of a plurality of components, calculating an amount of an admixture, cement, an environmental friendly additive and water needed according to the total amount of the concrete calculated in S1, to provide a basis for the preparation of each raw material.

S3: Mixing a plurality of dry materials of the admixture, wherein the admixture is selected from an effective gel composition in a construction debris, wherein the construction debris comprises at least one of concrete block, brick fragment, crushed stone, waste gypsum, waste mortar and dregs, wherein the admixture is sterilized.

S4: Adding a certain amount of cement, water and the environmental friendly additive into the admixture prepared in S3 respectively, stirring for mixing, to obtain the concrete to be determined.

S5: Detection: detecting whether the concrete to be determined prepared in S4 compliance with a quality standard, wherein forming the high-flow lightweight insulating concrete when up to the standard.

S6: Recycling, making the concrete into the effective gel composition when below the standard.

Preferably, in S3, adding an appropriate amount of quick lime into the admixture, stirring thoroughly, absorbing water in the admixture powder and water in the air after mixing with the admixture to generate strong alkaline calcium hydroxide, then absorbing carbon dioxide in the air slowly to generate weakly alkaline calcium carbonate, wherein the quick lime reacts with water inducing an exothermic reaction for sterilization.

Preferably, a reaction temperature is 150° C.−200° C. after the quick lime is mixed with the admixture.

Preferably, the water is selected from the group consisting of daily drinking water that meets the Chinese national drinking water standards, surface water and groundwater, wherein a plurality of water quality indicators are as following: pH is more than 4.5, a concentration of chloride is less than 1000 mg/L and a concentration of sulfate is less than 2000 mg/L.

Preferably, in S4, the environmental friendly additive uses a polycarboxylate water reducer as a water reducing component, and a plurality of refined sugar and a plurality of expanding agent are mixed with water to compound to obtain the environmental friendly additive.

Preferably, a composition ratio of the water reducing component is 15%-38%, a composition ratio of the refined sugar is 15%-20%, a composition ratio of the expanding agent is 10%-28%, and a composition ratio of the water is 14%-60%.

Preferably, in S4, the stirring is carried out by a stirring machine, wherein when stirring, a room temperature is 0° C.−35° C. and a stirring speed is 23 rpm-35 rpm.

The present invention has the following beneficial effects:

The present invention provides a high-flow lightweight insulating concrete and preparation method thereof, using effective gel in the construction debris as raw material. The renewable environmentally friendly active materials are prepared from the construction debris and have the characteristic of high-flow, which are suitable for the cast-in-place construction of the non-load-bearing wall. The construction process has advantages of simple, reliable, lightweight, high strength and cost-effective. And the non-load-bearing wall has the advantages of sound insulation, thermal insulation, is environmental friendly and durable.

### BRIEF DESCRIPTION OF THE DRAWINGS

FIGURE is a schematic flow chart of a preparation method of a high-flow lightweight insulating concrete according to the present invention.

### DETAILED DESCRIPTION OF THE INVENTION

The present invention is described below with reference to the accompanying drawings.

As shown in the FIGURE, the present invention includes cement, water, an admixture and an environmental friendly additive; wherein a mass ratio of the cement, admixture, environmental friendly additive and water is (15-25):(60-75):(0.5-1.5):(8-12). The admixture includes a coarse aggregate and a fine aggregate, wherein a mass ratio of the coarse aggregate and the fine aggregate is (36-45):(24-30), wherein a size of the coarse aggregate is 8-10 mm, a size of the fine aggregate is less than 5 mm.

A preparation method of a high-flow lightweight insulating concrete includes the steps of:

S1: Calculating a total amount of a concrete according to a casting area of a non-load-bearing wall.

S2: Determining a mass ratio of a plurality of components, calculating an amount of an admixture, cement, an environmental friendly additive and water needed according to the total amount of the concrete calculated in S1, to provide a basis for the preparation of each raw material.

S3: Mixing a plurality of dry materials of the admixture, wherein the admixture is selected from an effective gel composition in a construction debris, wherein the construction debris comprises at least one of concrete block, brick fragment, crushed stone, waste gypsum, waste mortar and dregs, wherein the admixture is sterilized. Adding an appropriate amount of quick lime into the admixture, stirring thoroughly, absorbing water in the admixture powder and water in the air after mixing with the admixture to generate strong alkaline calcium hydroxide, then absorbing carbon dioxide in the air slowly to generate weakly alkaline calcium carbonate. Wherein a reaction temperature is 150° C.−200° C. when the quick lime is mixed with the admixture.

S4: Adding a certain amount of cement, water and the environmental friendly additive into the admixture prepared in S3 respectively, stirring for mixing, to obtain the concrete to be determined. Wherein the water is selected from the group consisting of daily drinking water that meets the Chinese national drinking water standards, surface water and groundwater. Wherein a plurality of water quality indicators are as following: pH is more than 4.5, a concentration of chloride is less than 1000 mg/L and a concentration of sulfate is less than 2000 mg/L. The environmental friendly additive uses a polycarboxylate water reducer as a water reducing component, and a plurality of refined sugar and a plurality of expanding agent are mixed with water to compound to obtain the environmental friendly additive. Wherein a composition ratio of the water reducing component is 15%-38%, a composition ratio of the refined sugar is 15%-20%, a composition ratio of the expanding agent is 10%-28%, and a composition ratio of the water is 14%-60%. Wherein the stirring is carried out by a stirring machine, wherein when stirring, a room temperature is 0° C.−35° C. and a stirring speed is 23 rpm-35 rpm.

S5: Detection: detecting whether the concrete to be determined prepared in S4 compliance with a quality standard, wherein forming the high-flow lightweight insulating concrete when up to the standard.

S6: Recycling, making the concrete into the effective gel composition when below the standard.

In summary, the present invention provides a high-flow lightweight insulating concrete and preparation method thereof, using effective gel in the construction debris as raw material. The renewable environmentally friendly active materials are prepared from the construction debris and have the characteristic of high-flow, which are suitable for the cast-in-place construction of the non-load-bearing wall. The construction process has advantages of simple, reliable, lightweight, high strength and cost-effective. And the non-load-bearing wall has the advantages of sound insulation, thermal insulation, is environmental friendly and durable.

Those skilled in the art can implement the present invention in various modifications without departing from the spirit and scope of the present invention. The foregoing descriptions are merely preferred embodiments of the present invention, and do not limit the scope of the present invention. Equivalent structural changes made based on the description and the accompanying drawings of the present invention are included in the scope of the invention.

1. A high-flow lightweight insulating concrete, comprising cement and water, wherein the concrete further comprises an admixture and an environmental friendly additive;
wherein a mass ratio of the cement, admixture, environmental friendly additive and water is (15-25):(60-75):(0.5-1.5):(8-12).

2. The high-flow lightweight insulating concrete according to claim 1, wherein the admixture comprises a coarse aggregate and a fine aggregate.

3. The high-flow lightweight insulating concrete according to claim 2, wherein a mass ratio of the coarse aggregate and the fine aggregate is (36-45):(24-30).

4. The high-flow lightweight insulating concrete according to claim 3, wherein a size of the coarse aggregate is 8-10 mm, a size of the fine aggregate is less than 5 mm.

5. A preparation method of a high-flow lightweight insulating concrete, comprising the steps of:
S1: calculating a total amount of the concrete according to a casting area of a non-load-bearing wall;
S2: determining a mass ratio of a plurality of components, calculating an amount of an admixture, cement, an environmental friendly additive and water needed according to the total amount of the concrete calculated in S1, to provide a basis for the preparation of each raw material;
S3: mixing a plurality of dry materials of the admixture, wherein the admixture is selected from an effective gel composition in a construction debris, wherein the construction debris comprises at least one of concrete block, brick fragment, crushed stone, waste gypsum, waste mortar and dregs, wherein the admixture is sterilized;
S4: adding a certain amount of cement, water and the environmental friendly additive into the admixture prepared in S3 respectively, stirring for mixing, to obtain the concrete to be determined;
S5: detection: detecting whether the concrete to be determined prepared in S4 compliance with a quality standard, wherein forming the high-flow lightweight insulating concrete when up to the standard;
S6: recycling, making the concrete into the effective gel composition when below the standard.

6. The preparation method of a high-flow lightweight insulating concrete according to claim 5, wherein in S3, adding an appropriate amount of quick lime into the admixture, stirring thoroughly, absorbing water in the admixture powder and water in the air after mixing with the admixture to generate a strong alkaline calcium hydroxide, then absorbing carbon dioxide in the air slowly to generate a weakly alkaline calcium carbonate, wherein the quick lime reacts with water inducing an exothermic reaction for sterilization.

7. The preparation method of a high-flow lightweight insulating concrete according to claim 5, wherein a reaction temperature is 150° C.-200° C. after the quick lime is mixed with the admixture.

8. The preparation method of a high-flow lightweight insulating concrete according to claim 5, wherein the water is selected from the group consisting of daily drinking water that meets the Chinese national drinking water standards, surface water and groundwater, wherein a plurality of water quality indicators are as following: pH is more than 4.5, a concentration of chloride is less than 1000 mg/L and a concentration of sulfate is less than 2000 mg/L.

9. The preparation method of a high-flow lightweight insulating concrete according to claim 5, wherein in S4, the environmental friendly additive uses a polycarboxylate water reducer as a water reducing component, and a plurality of refined sugar and a plurality of expanding agent are mixed with water to compound to obtain the environmental friendly additive.

10. The preparation method of a high-flow lightweight insulating concrete according to claim 9, wherein a composition ratio of the water reducing component is 15%-38%, a composition ratio of the refined sugar is 15%-20%, a composition ratio of the expanding agent is 10%-28%, and a composition ratio of the water is 14%-60%.

11. The preparation method of a high-flow lightweight insulating concrete according to claim 5, wherein in S4, the stirring is carried out by a stirring machine, wherein when stirring, a room temperature is 0° C.−35° C. and a stirring speed is 23 rpm-35 rpm.
